(19) United States
(12) Patent Application Publication
(10) Pub. No.: US 2007/0107700 A1
(43) Pub. Date: May 17, 2007

(54) Side mounted fuel pump module with bottom referencing filter

(76) Inventors: Jeffery J. Milton, Lake Orion, MI (US); Kenneth J. Preston, Royal Oak, MI (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/542,222

(22) Filed: Oct. 4, 2006

Related U.S. Application Data
(60) Provisional application No. 60/723,750, filed on Oct. 5, 2005.

(51) Int. Cl. F04B 35/00; F02M 37/04

(52) U.S. Cl. 123/509; 417/363

(57) ABSTRACT

A fuel pump module is provided for delivering fuel to an engine. The module includes a fuel pump for pumping fuel to the engine. The fuel pump is constructed and arranged to be mounted to a side of a fuel tank. A filter is provided for filtering fuel prior entering the fuel pump. The filter includes spring structure operatively associated therewith to bias the filter into engagement with a bottom of the fuel tank.

This application claims the benefit of the earlier filing date of U.S. Provisional Application No. 60/723,750, filed on Oct. 5, 2005, which is incorporated by reference herein in its entirety.

### FIELD OF THE INVENTION

This invention relates to fuel pump modules for automotive applications and, more particularly, to a side mounted fuel pump module and a fuel tank arrangement.

### BACKGROUND OF THE INVENTION

Conventional side mounted fuel pump modules for vehicle applications are mounted generally to a side of a fuel tank with a filter of the module referencing a bottom the fuel tank. The module includes a fuel pump such that in normal operation, the fuel pump draws fuel through the filter and delivers fuel to an engine of the vehicle. However, during hard turns of a vehicle employing a conventional module, fuel may not be in a location in the tank so as to be drawn through the filter and thus to the engine.

Thus, there is a need to provide a side mounted fuel pump module that delivers fuel to a vehicle effectively even under hard turning conditions of a vehicle.

### SUMMARY OF THE INVENTION

An object of the invention is to fulfill the need referred to above. In accordance with the principles of the present invention, this objective is achieved by providing a fuel pump module and fuel tank arrangement for delivering fuel to an engine.

The arrangement includes a fuel module having a fuel pump for pumping fuel to the engine, and a filter for filtering fuel prior entering the fuel pump. The arrangement also includes a fuel tank. The fuel module is mounted to a side of the fuel tank with the filter referencing a bottom of the fuel tank. The fuel tank includes fuel trapping structure constructed and arranged to trap fuel in the tank near the filter.

In accordance with another aspect of the invention, a method of ensuring that fuel is available to be delivered to an engine provides a fuel module having a fuel pump for pumping fuel to the engine and a filter for filtering fuel prior entering the fuel pump. The fuel module is mounted to a side of the fuel tank with the filter referencing the bottom of the fuel tank. Fuel trapping structure is provided in the fuel tank to trap fuel in the tank near the filter.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification

### BRIEF DESCRIPTION OF THE DRAWINGS

The invention will be better understood from the following detailed description of the preferred embodiments thereof, taken in conjunction with the accompanying drawing, wherein like reference numerals refer to like parts, in which:

FIG. 1 shows a side mounted fuel pump module, in accordance with an embodiment of the invention.

FIG. 2 is a top schematic view of the module of FIG. 1 shown mounted in a fuel tank.

FIG. 3 is a side schematic view of the module and fuel tank of FIG. 2.

### DETAILED DESCRIPTION OF THE EXEMPLARY EMBODIMENT

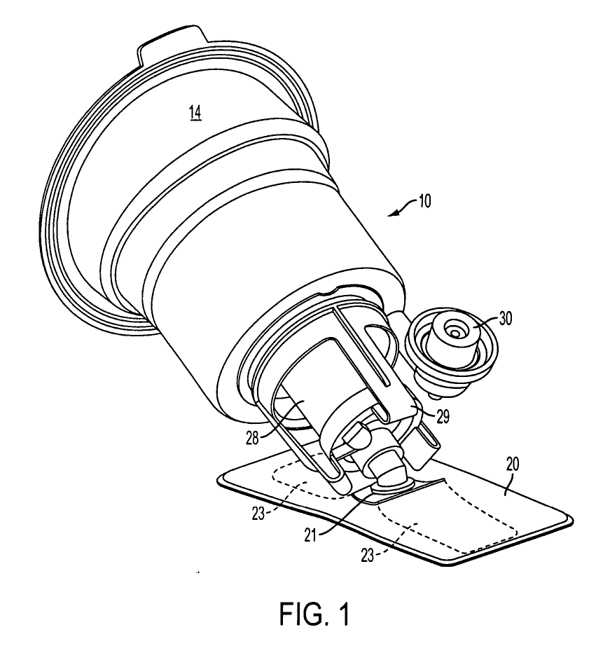

With reference to FIG. 1, a side mounted fuel pump module, generally indicated at 10, is shown in accordance with the principles of an embodiment of the present invention. The module 10 includes a flange 14 that mounts to a side 16 of a fuel tank 12 (see FIG. 3) of a vehicle.

The module 10 includes a pump retaining structure 29 of the type disclosed in U.S. application Ser. No. 11/472,286, the contents of which is hereby incorporated by reference in its entirety into this specification. The pump retaining structure 29 is coupled with a fuel filter 20. The filter 20 references the bottom 17 of the fuel tank 12 (FIG. 3) and conforms to the tank shape. The filter 20 filters fuel in the tank 12 prior to being drawn into the fuel pump 28. The pump 28 of the module 10 is preferably disposed at an angle of about 35 degrees with respect to the bottom 17 of the fuel tank 12. The module 10 also includes a fuel pressure regulator 30 mounted to the retaining structure 29 to regulate fuel pressure in the conventional manner. The module 10 can be used in gasoline or diesel fueled vehicles.

As shown in FIG. 1, the filter 20, preferably of the sock-type, surrounds the inlet 21 of the fuel pump 28. In the embodiment of FIG. 1, the filter 20 incorporates spring structure within an interior thereof. The spring structure preferably includes at least one leaf spring 23 made integral with the filter 20. In the illustrated embodiment, two leaf springs 23 are provided. The leaf springs 23 are preferably made of the same Acetal Polyoxymethylene Copolymer (POM) material that conventional fuel filters are made of. Conventional spacers (not shown) are preferably provided in the filter 20 so as to maintain the desired shape of the filter.

Thus, one or more simple, cantilevered springs 23 are attached at one end thereof directly to a portion 21 of the pump 28 with the other end of the spring 23 extending within the interior of the filter 20 to press the filter against the inside bottom of the fuel tank 12. The spring(s) 23 allows for the natural variation of the height of the tank 12 and the module 10. The springs 23 are flexible so that if the filter 20 is near a wall (e.g., wall 22) of the tank 12, the filter 20 and springs 23 therein can engage the wall.

Although the spring structure (springs 23) is shown to be provided within the filter 20, it can be appreciated that the spring structure can be operatively associated with the filter in any manner (e.g. outside of the filter), so long as the spring structure bias the filter 20 towards the bottom of the fuel tank. In addition, the spring structure 23 can be defined by modifying internal features (such as ribs) inside of conventional filters so as to provide the biasing function.

The filter 20 with associated spring structure 23 can be used within any bottom-referencing type fuel module. Thus, with the spring structure 23 associated with the filter 20, no struts and associated springs are needed to take up tolerances, yet the fuel pump 28 is still bottom referenced for low fuel drivability.

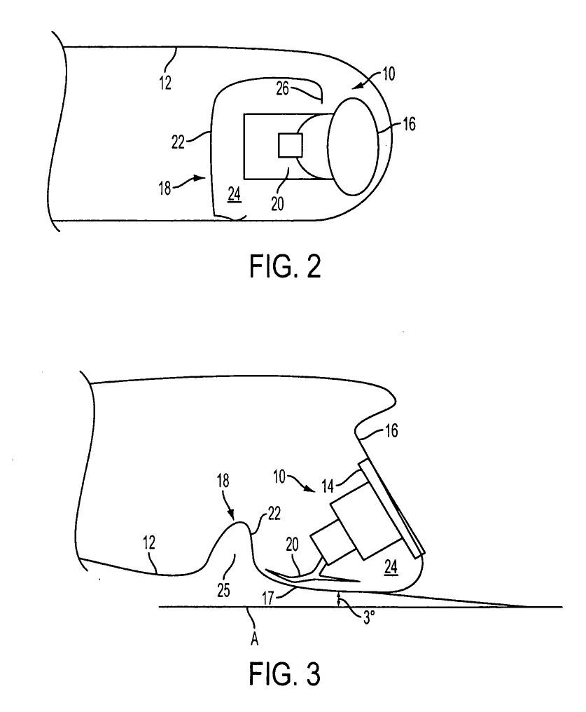

As shown in FIGS. 2 and 3, the fuel tank 12 includes a generally C-shaped fuel trapping structure, generally indicated at 18, constructed and arranged to partially surround an area of the bottom 17 of the fuel tank 12 and thereby trap fuel in the fuel tank 12 near the fuel filter 20 of the module 10. As best shown in FIG. 3, the bottom 17 of the fuel tank 12 has a slope of about 3 degrees, with respect to horizontal axis A, toward the module 10 and the fuel trapping structure 18. The fuel trapping structure 18 includes a wall 22 extending upwardly from the bottom 17, into the fuel tank 12, to define a fuel reservoir 24. Thus, due to the sloping of the tank 12 and the wall 22, fuel in the tank 12 collects in the reservoir 24. Hence, even if a vehicle is negotiating a hard turn, fuel is still available in the reservoir 24 to be delivered by the module 10 to the engine of the vehicle.

In the embodiment, the wall 22 is defined by a recess 25 created in bottom 17, outside of the fuel tank 12. The wall 22 is preferably tapered at end 26 and is of sufficient height to trap fuel. It can be appreciated that fuel can pass over the top of the wall 22.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

1. A fuel pump module for delivering fuel to an engine, the module comprising:
a fuel pump for pumping fuel to the engine, the fuel pump being constructed and arranged to be mounted to a side of a fuel tank, and
a filter for filtering fuel prior entering the fuel pump, the filter including spring structure operatively associated therewith to bias the filter into engagement with a bottom of the fuel tank.

2. The module of claim 1, further including a flange constructed and arranged to be mounted to the side of the fuel tank.

3. (canceled)

4. (canceled)

5. (canceled)

6. The module of claim 1, wherein the spring structure includes at least one leaf spring coupled at one end thereof to a portion of the fuel pump with another end of the leaf spring extending within an interior of the filter.

7. The module of claim 1, wherein the filter is constructed and arranged to conform to the shape of the bottom of the tank.

8. (canceled)

9. A fuel pump module and for delivering fuel to an engine, the module comprising:
a fuel pump for pumping fuel to the engine, the fuel pump being constructed and arranged to be mounted to a side of a fuel tank, and
a filter for filtering fuel prior entering the fuel pump, the filter including means, operatively associated therewith, for biasing the filter into engagement with a bottom of the fuel tank.

10. (canceled)

11. The module of claim 9, further including a flange constructed and arranged to be mounted to the side of the fuel tank.

12. (canceled)

13. (canceled)

14. The module of claim 9, wherein the means for biasing includes spring structure.

15. The module of claim 14, wherein the spring structure includes at least one leaf spring coupled at one end thereof to a portion of the fuel pump with another end of the leaf spring extending within an interior of the filter.

16. The module of claim 9, wherein the filter is constructed and arranged to conform to the shape of the bottom of the tank.

17. (canceled)

18. (canceled)

19. (canceled)

20. (canceled)
